(19) United States
(12) Patent Application Publication
(10) Pub. No.: US 2010/0279148 A1
(43) Pub. Date: Nov. 4, 2010

(54) NICKEL-BASED ALLOYS AND TURBINE COMPONENTS

(75) Inventor: Yiping Hu, Greer, SC (US)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/433,175

(22) Filed: Apr. 30, 2009

(51) Int. Cl. B32B 15/01; C22C 19/03; C22C 19/05

(52) U.S. Cl. 428/680; 420/455; 420/443; 420/445

(57) ABSTRACT

Nickel-based alloys and turbine components are provided. In an embodiment, by way of example only, a nickel-based alloy includes, by weight, about 29.5 percent to about 31.5 percent aluminum, about 0.20 percent to about 0.60 percent hafnium, about 0.08 percent to about 0.015 percent yttrium, and a balance of nickel. In another embodiment, by way of example only, a nickel-based alloy includes, by weight, about 9.7 percent to about 10.3 percent of cobalt, about 15.5 percent to about 16.5 percent of chromium, about 6.6 percent to about 7.2 percent of aluminum, about 5.7 percent to about 6.3 percent of tantalum, about 2.7 percent to about 3.3 percent of tungsten, about 1.8 percent to about 2.3 percent of rhenium, about 0.20 percent to about 1.2 percent of hafnium, about 0.20 percent to about 0.60 percent of silicon, and a balance of nickel.

The inventive subject matter generally relates to alloys, and more particularly relates to nickel-based alloys and turbine components.

### BACKGROUND

Turbine engines are used as the primary power source for various kinds of aircraft. Turbine engines may also serve as auxiliary power sources that drive air compressors, hydraulic pumps, and industrial electrical power generators. Most turbine engines generally follow the same basic power generation procedure. Compressed air is mixed with fuel and burned to form expanding hot combustion gases, which are directed against stationary turbine vanes in the turbine engine. The stationary turbine vanes turn the gas flow partially sideways to impinge onto turbine blades mounted on a rotatable turbine disk. The force of the impinging gas causes the turbine disk to spin at a high speed. Jet propulsion engines use the power created by the rotating turbine disk to draw more air into the engine, and the high velocity combustion gas is passed out of the gas turbine aft end to create forward thrust. Other engines use this power to turn one or more propellers, electrical generators or other devices.

Many turbine engine blades and vanes are fabricated from high temperature materials, such as nickel-based or cobalt-based superalloys. Although nickel-based and cobalt-based superalloys have good high temperature properties and many other advantages, they may be susceptible to corrosion, oxidation, thermal fatigue, and/or erosion damage in the high temperature environment of an operating turbine engine. These limitations are undesirable as there is a constant drive to increase engine operating temperatures in order to increase fuel efficiency and to reduce emissions. Additionally, replacing damaged turbine engine components made from nickel-based and cobalt-based superalloys is expensive.

Accordingly, it is desirable to fabricate turbine engine components that are more robust than conventionally-fabricated components. Moreover, it is desirable to have more cost-effective ways to repair the components, if they become damaged or degraded. Furthermore, other desirable features and characteristics of the inventive subject matter will become apparent from the subsequent detailed description of the inventive subject matter and the appended claims, taken in conjunction with the accompanying drawings and this background of the inventive subject matter.

### BRIEF SUMMARY

Nickel-based alloys and turbine components are provided.

In an embodiment, by way of example only, a nickel-based alloy includes, by weight, about 29.5 percent to about 31.5 percent aluminum, about 0.20 percent to about 0.60 percent hafnium, about 0.08 percent to about 0.015 percent yttrium, and a balance of nickel.

In another embodiment, by way of example only, a nickel-based alloy includes, by weight, about 9.7 percent to about 10.3 percent of cobalt, about 15.5 percent to about 16.5 percent of chromium, about 6.6 percent to about 7.2 percent of aluminum, about 5.7 percent to about 6.3 percent of tantalum, about 2.7 percent to about 3.3 percent of tungsten, about 1.8 percent to about 2.3 percent of rhenium, about 0.20 percent to about 1.2 percent of hafnium, about 0.20 percent to about 0.60 percent of silicon, and a balance of nickel.

In still another embodiment, by way of example only, a component includes a substrate comprising a first alloy and a welded portion on the substrate, the welded portion comprising a second alloy that is different in formulation than the first alloy and selected from a group consisting of a first formulation and a second formulation. The first formulation comprises, by weight about 29.5 percent to about 31.5 percent aluminum, about 0.20 percent to about 0.60 percent hafnium, about 0.08 percent to about 0.015 percent yttrium, and a balance of nickel. The second formulation comprises, by weight about 9.7 percent to about 10.3 percent of cobalt, about 15.5 percent to about 16.5 percent of chromium, about 6.6 percent to about 7.2 percent of aluminum, about 5.7 percent to about 6.3 percent of tantalum, about 2.7 percent to about 3.3 percent of tungsten, about 1.8 percent to about 2.3 percent of rhenium, about 0.20 percent to about 1.20 percent of hafnium, about 0.20 percent to about 0.60 percent of silicon, and a balance of nickel.

In still another embodiment, by way of example only, a turbine component includes a substrate comprising a first alloy and a bond coat over the substrate. The bond coat comprises a second alloy including about 31.0 percent aluminum, about 0.25 percent to about 0.5 percent hafnium, about 0.01 percent yttrium, and a balance of nickel.

### BRIEF DESCRIPTION OF THE DRAWINGS

The inventive subject matter will hereinafter be described in conjunction with the following drawing figures, wherein like numerals denote like elements, and

FIG. 1 is a perspective view of a turbine engine component, according to an embodiment;

FIG. 2 is a cross-sectional view of a portion of a turbine engine component, according to an embodiment;

FIG. 3 is a cross-sectional view of a protective coating system that may be included over a turbine engine component, according to an embodiment; and

FIG. 4 is a flow diagram of a method to form a turbine engine component, according to an embodiment.

### DETAILED DESCRIPTION

The following detailed description is merely exemplary in nature and is not intended to limit the inventive subject matter or the application and uses of the inventive subject matter. Furthermore, there is no intention to be bound by any theory presented in the preceding background or the following detailed description.

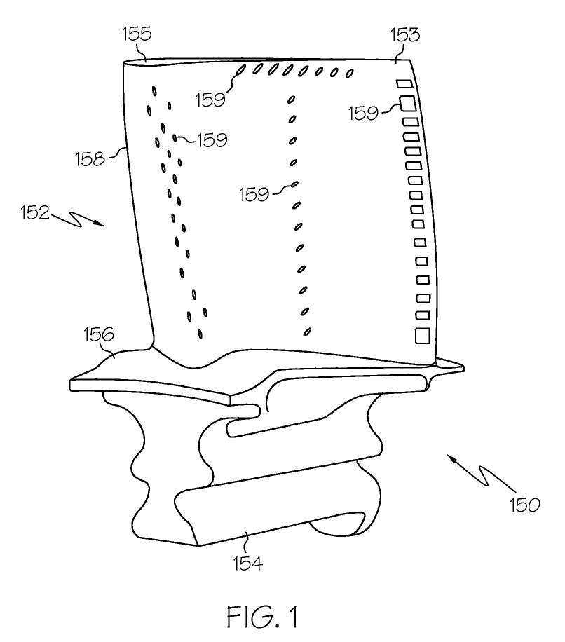

FIG. 1 is a perspective view of a turbine engine component 150, according to an embodiment. Here, the turbine engine component 150 is shown as a turbine blade. However, in other embodiments, the turbine engine component 150 may be a turbine nozzle guide vane or another component that may be implemented in a gas turbine engine or other high-temperature engine system. In an embodiment, the turbine engine component 150 may include an airfoil 152 that includes a pressure side surface 153, an attachment portion 154, a leading edge 158 including a blade tip 155, and/or a platform 156. In accordance with an embodiment, the turbine engine component 150 may be formed with a non-illustrated outer shroud attached to the tip 155. The turbine engine component 150 may have non-illustrated internal air-cooling passages that remove heat from the turbine airfoil. After the internal air has absorbed heat from the blade, the air is discharged into a hot gas flow path through passages 159 in the airfoil wall. Although the turbine engine component 150 is illustrated as including certain parts and having a particular shape and dimension, different shapes, dimensions and sizes may be alternatively employed depending on particular gas turbine engine models and particular applications.

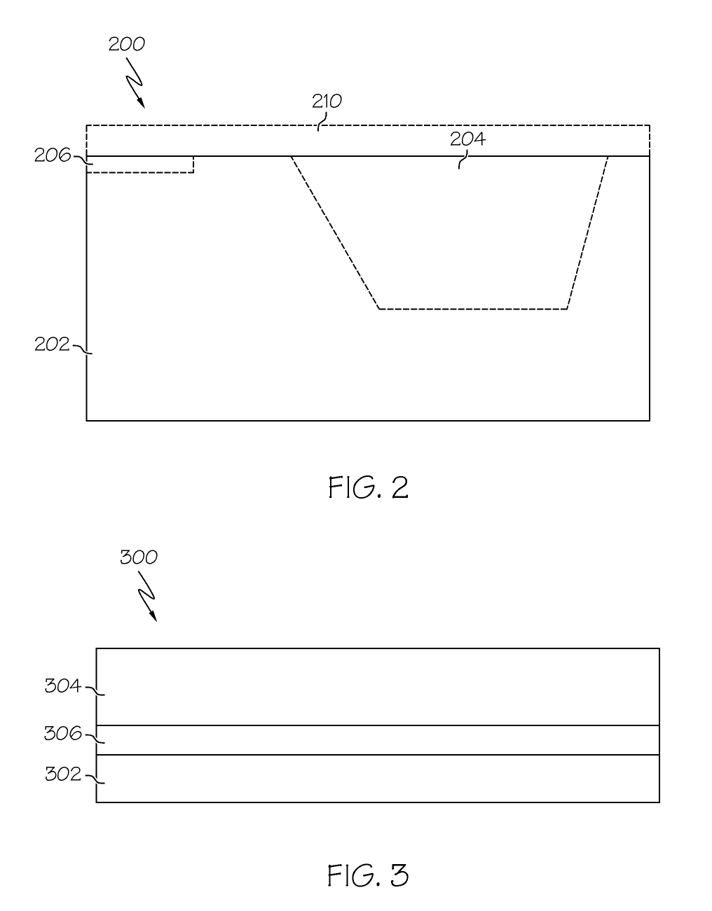

FIG. 2 is a cross-sectional view of a portion of a turbine engine component 200, according to an embodiment. The portion may be included on one or more of a leading edge, trailing edge or parapet or flat solid tip of a blade, in an embodiment. In another embodiment in which the blade may have a knife seal, the portion may be defined as an edge of the blade. In any case, the turbine engine component 200 may include a base material 202 and one or more welded portions in the form of one or more deep cracks 204 or built-up sections of a blade tip 206 (referred to below as “welded portions 204, 206”). Although the built-up section of the blade tip 206 is shown as extending over a portion of the base material 202, in other embodiments, the built-up section 206 may extend over an entirety of the base material 202 to thereby cover an entire tip of the component 200. Additionally, though a dotted line is shown between the base material 202 and the welded portions 204, 206, it will be appreciated that in an embodiment, the two may be seamless and metallurgical bonding or a metallurgical interface therebetween may be produced during welding repair. In some embodiments, as shown in phantom, a protective coating system 210 may be deposited over the turbine engine component 200.

In an embodiment, the base material 202 comprises a first alloy, such as a nickel-based superalloy including, but not limited to IN738, IN792, C101, MarM247, Rene80, Rene125, ReneN5, SC180, CMSX 4, and PWA1484. In other embodiments, the base material 202 may comprise a cobalt-based superalloy or another superalloy conventionally employed for the fabrication of turbine engine components.

The welded portions 204, 206 include a second alloy, which may comprise a nickel-based alloy or a nickel-based superalloy having a composition that is different than the composition of the first alloy. As used herein, the term “nickel-based alloy” may include “nickel-based superalloy”. In an embodiment, the second alloy may have a first formulation that has oxidation-resistance properties that are greatly improved over those of the first alloy. The first formulation of the nickel-based alloy includes nickel, aluminum, hafnium, and yttrium, which may form an intermetallic phase such as a β-NiAl phase. In still another embodiment, the first formulation of the nickel-based alloy may include incidental impurities (e.g., trace amounts of additional elements that are not intentionally included in the composition), but does not include other elements other than those listed previously (e.g., nickel, aluminum, hafnium, yttrium, and/or chromium). For example, the first formulation of the nickel-based alloy may include, by weight, aluminum in a range of about 29.5 percent to about 31.5 percent, hafnium in a range of about 0.20 percent to about 0.60 percent, yttrium in a range of about 0.08 percent to about 0.015 percent, and a balance of nickel. In still another embodiment, the first formulation of the nickel-based alloy may include about 31.0 percent aluminum, about 0.25 percent to about 0.5 percent hafnium, about 0.01 percent yttrium, and a balance of nickel. Inclusion of a greater percentage of aluminum as compared with conventional nickel-based superalloys promotes formation of a protective oxide layer on a surface of the welded portion (e.g., blade tip 206), which protects the outer surface of the welded portion (e.g., blade tip 206) against oxidation. The hafnium atoms diffuse into grain boundaries of the aluminum oxides within the nickel-based alloy to decrease a rate at which the protective oxide layer grows over the welded portion (e.g., blade tip 206) so that the protective oxide layer remains relatively thin. As a result, spallation of the protective oxide layer may be minimized, and the presence of the protective oxide layer may provide additional oxidation resistance for the alloy. Yttrium is included in the composition of the nickel-based alloy to react with sulfur that may be present in the turbine engine component 200. The yttrium forms stable sulfides with the sulfur to prevent the sulfur from diffusing to the surface of the nickel-based alloy. This may also improve the adherence of protective oxide layer to the alloy.

In another embodiment in which increased oxidation-resistance is desired, the first formulation of the nickel-based alloy may further include chromium. In an example, chromium may be present in the first formulation of the nickel-based alloy in a range of about 4.7 percent to about 5.3 percent, by weight. In another embodiment, the first formulation may include about 5.0 percent chromium, by weight. By including about 5.0 percent, by weight, of chromium, the chromium may contribute to the formation of a chromium oxide scale over the welded portion (e.g., blade tip 206).

In any case, although the first formulation of the nickel-based alloy may provide oxidation-resistance at elevated temperatures (e.g., temperatures greater than about 1100° C.), it may be relatively brittle. Thus, in an embodiment, the first formulation of the nickel-based alloy may be employed for the blade tip 206 as a coating having a thickness in a range of about 75 microns to about 250 microns. In other embodiments, the coating may be thicker or thinner.

In another embodiment, the second alloy may have environmental-resistance properties that are greatly improved over those of the first alloy. In such a case, the second alloy may be employed for repairing cracks 204 and blade tip 206 and may have a second formulation that includes, in addition to nickel, elements selected from cobalt, chromium, aluminum, tantalum, tungsten, rhenium, hafnium, silicon, carbon, boron, and yttrium. For example, the second formulation of the nickel-based alloy may include, by weight, cobalt in a range of from about 9.7 percent to about 10.3 percent, chromium in a range of from about 15.5 percent to about 16.5 percent, aluminum in a range of from about 6.6 percent to about 7.2 percent, tantalum in a range of from about 5.7 percent to about 6.3 percent, tungsten in a range of from about 2.7 percent to about 3.3 percent, rhenium in a range of from about 1.8 percent to about 2.3 percent, hafnium in a range of from about 0.20 percent to about 1.2 percent, silicon in a range of from about 0.20 percent to about 0.60 percent, and a balance of nickel (and incidental impurities). In another embodiment, the second formulation of the nickel-based alloy may include, by weight, about 10.0 percent cobalt, about 16.0 percent chromium, about 6.8 percent aluminum, about 6.0 percent tantalum, about 3.0 percent tungsten, about 2.0 percent rhenium, about 0.25 percent hafnium, about 0.4 percent silicon, and a balance of nickel (and incidental impurities).

As noted above, by including aluminum and chromium in the second formulation of the nickel-based alloy, oxidation resistance properties of the alloy may be improved over conventional nickel-based superalloys because the aluminum and chromium may react with oxygen to form a protective alumina and chromia scales over the nickel-based alloy, and the protective scales may protect the second alloy against oxidation. Additionally, because the percentage of chromium in the second formulation of the nickel-based alloy is relatively high as compared to conventional nickel-based superalloys, corrosion-resistance properties may be imparted to the alloy. Moreover, the silicon in the alloy reacts with oxygen to form silica, which contributes to the formation of a protective oxide scale. In order to prevent the oxide layer from becoming undesirably thick, hafnium is included. In an embodiment, the hafnium also may contribute to the environment-resistance properties of the nickel-based alloy by diffusing to the grain boundaries of alumina scale to slow down its growth rate This may improve the adherence of the thin protective layer to the base material 202. Cobalt may increase solubility of the gamma matrix of the alloy to prevent topologically close-packed (“TCP”) phases from forming. Cobalt also enhances corrosion-resistant properties of the alloy. Tungsten is included to strengthen the gamma matrix of the alloy to improve its mechanical properties. Rhenium may be included to partition to the gamma matrix of the alloy to enhance the negative lattice misfit between the gamma matrix and gamma prime phases, which may improve creep resistance of the alloy. Rhenium may also prevent gamma prime particles from coarsening, which may greatly improve the elevated-temperature properties of the alloy. Tantalum may mainly partition to the gamma prime phase to improve the elevated-temperature properties of the alloy.

In another embodiment, the second formulation of the nickel-based alloy additionally may include yttrium at about 0.01 percent, by weight. Yttrium may contribute to the environment-resistant properties of the nickel-based alloy by reacting with sulfur and forming stable sulfides. In still another embodiment, the nickel-based alloy may further include carbon at about 0.06 percent, by weight and/or boron at about 0.01 percent, by weight. Carbon and boron are included to strengthen grain boundaries.

To further protect the turbine engine component 200 from the harsh operating environment of an engine, the turbine engine component 200 may include a protective coating system 210, in an embodiment. FIG. 3 is a cross-sectional view of a protective coating system 300 that may be included over a turbine engine component, according to an embodiment. The protective coating system 300 may include a bond coating 302, a thermal barrier coating 304, and one or more intermediate layers there between, such as a thermally grown oxide (TGO) 306.

According to an embodiment, the bond coating 302 may be a diffusion aluminide coating. For example, the diffusion aluminide coating may be formed by depositing an aluminum layer over the base material 202 (FIG. 2) and/or the welded portions 204, 206 (FIG. 2), and subsequently diffusing the aluminum layer therewith the substrate to form aluminide coating. According to one embodiment, the diffusion aluminide coating is a simple diffusion aluminide, including a single layer made up of aluminum interacting with the base material 202 and/or the welded portions 204, 206. In another embodiment, the diffusion aluminide coating may have a more complex structure and may include one or more additional metallic layers that are diffused into the aluminum layer, the base material 202, and/or the welded portions 204, 206. For example, an additional metallic layer may include a platinum layer, a hafnium and/or a zirconium layer, or a co-deposited hafnium, zirconium, and platinum layer. In another embodiment, the bond coating 302 may be an overlay coating comprising MCrAlX, wherein M is an element selected from cobalt, nickel, or combinations thereof, and X is an element selected from hafnium, zirconium, yttrium, tantalum, rhenium, ruthenium, palladium, platinum, silicon, or combinations thereof. Some examples of MCrAlX compositions include NiCoCrAlY and CoNiCrAlY. In another exemplary embodiment, the bond coating 302 may include a combination of two types of bond coatings, such as a diffusion aluminide coating formed on an MCrAlX coating. In still another embodiment, the bond coating 302 may comprise the nickel-based alloy described above in conjunction with the second alloy. In particular, the bond coating 302 may comprise the first formulation of the nickel-based alloy and includes, by weight, about 31.0 percent aluminum, about 0.25 percent to about 0.5 percent hafnium, about 0.01 percent yttrium, and a balance of nickel, and in some embodiments, about 5.0 percent chromium. In any case, the bond coating 302 may have a thickness in a range of from about 25 microns (μm) to about 150 μm, according to an embodiment. In other embodiments, the thickness of the bond coating 302 may be greater or less.

The thermal barrier coating 304 may be formed over the bond coating 302 and may comprise, for example, a ceramic. In one example, the thermal barrier coating 304 may comprise a partially stabilized zirconia-based thermal barrier coating, such as yttria stabilized zirconia (YSZ). In an embodiment, the thermal barrier coating may comprise yttria stabilized zirconia doped with other oxides, such as Gd₂O₃, TiO₂, and the like. In another embodiment, the thermal barrier coating 304 may have a thickness that may vary and may be, for example, in a range from about 50 μm to about 300 μm. In other embodiments, the thickness of the thermal barrier coating 304 may be in a range of from about 100 μm to about 250 μm. In still other embodiments, the thermal barrier coating 304 may be thicker or thinner than the aforementioned ranges.

The thermally-grown oxide layer 306 may be located between the bond coating 302 and the thermal barrier coating 304. In an embodiment, the thermally-grown oxide layer 306 may be grown from aluminum in the above-mentioned materials that form the bond coating 302. For example, after a heat treatment during deposit of bond coating 302, oxidation may occur thereon to result in the formation of the oxide layer 306. In one embodiment, the thermally-grown oxide layer 306 may be relatively thin, and may be less than 5 μm thick.

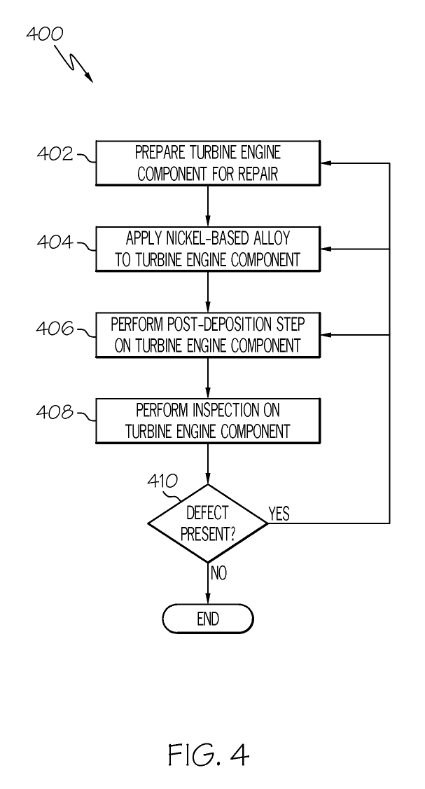

To fabricate or refurbish the turbine engine component, a method 400, depicted in a flow diagram provided in FIG. 4, may be employed. Although the following method 400 is described with reference to a turbine blade, it should be understood that the method 400 is not limited to blades or any other particular components. According to an embodiment, the turbine engine component is prepared, step 402. In an embodiment, the turbine engine component may be cast from a nickel-based superalloy, such as one described above. In another embodiment, the turbine engine component may be prepared by identifying one or more target surfaces that may need dimension restoration and oxidation or corrosion protection. For example, the target surfaces may include tip edges or leading or trailing edges on the turbine blade or platform areas. In an embodiment, step 402 may include chemically preparing the surface of the turbine engine component at least in proximity to and/or on the target surfaces. In an example, in an embodiment in which the turbine engine component is a worn component and includes an outer environment-protection coating, the coating may be removed. Thus, a chemical stripping solution may be applied to at least the target surfaces of the turbine engine component. Suitable chemicals used to strip the coating may include, for example, nitric acid solution. However, other chemicals may alternatively be used, depending on a particular composition of the coating.

In another embodiment of step 402, the turbine engine component may be mechanically prepared. Examples of mechanical preparation include, for example, pre-repair machining, degreasing surfaces in proximity to the target surface in order to remove any oxides, dirt or other contaminants, mechanically grinding the target surfaces, and/or grit-blasting the target surfaces. In another embodiment, additional or different types and numbers of preparatory steps can be performed, such as visual and/or fluorescent penetrant inspections. It will be appreciated that the present embodiment is not limited to these preparatory steps, and that additional, or different types and numbers of preparatory steps can be conducted.

Once the turbine engine component has been prepared, a nickel-based alloy may be applied thereto, step 404. In an embodiment, the nickel-based alloy may be laser-welded onto the target surfaces. In an example, the nickel-based alloy may comprise any one of the above-described alloy compositions used for welded portions 204, 206 (FIG. 2). The nickel-based alloy may be provided as substantially spherical powder particles, which provide improved powder flow property and may help maintain a stable powder feed rate during the welding process. The nickel-based alloy powder may be used in conjunction with a CO₂ laser, a YAG laser, a diode laser, or a fiber laser. In an embodiment, a welding process includes laser powder fusion welding, in which the nickel-based alloy is laser deposited onto a target surface to restore both geometry and dimension with metallurgically sound buildup. Both automatic and manual laser welding systems are widely used to perform laser powder fusion welding processes. An exemplary manual welding repair is described in detail in U.S. Pat. No. 6,593,540 entitled “Hand Held Powder-Fed Laser Fusion Welding Torch” and incorporated herein by reference. An exemplary automatic laser welding repair is also described in detail in U.S. Pat. No. 7,250,081 B2 entitled “Methods For Repair Of Single Crystal Alloys By Laser Welding And Products Thereof” and incorporate herein by reference.

In another embodiment, applying the nickel-based alloy to the target surfaces may include plasma transfer arc (PTA), micro plasma, and tungsten inert gas (TIG) welding methods. In still other embodiments, the step of applying the nickel-based alloy may include performing a thermal spray process such as high velocity oxygen fuel (HVOF), argon-shrouded plasma spraying or low pressure plasma spraying (LPPS) methods.

Returning to the flow diagram of FIG. 4, after the application step 404 is completed at least one post-deposition step is performed on the turbine engine component, step 406. A particular post-deposition step may depend on the type of application process that was performed in step 404. For example, if a spraying repair process was performed on the turbine blade, then one exemplary post-deposition step is a hot isostatic pressing (HIP) process performed for about four hours at about 2200° F. (about 1205° C.) with an applied pressure of about 15 ksi. In another embodiment, the post-deposition step 406 can further include additional processes that improve the mechanical properties and metallurgical integrity of the turbine engine component. In embodiments in which step 404 included applying the first formulation of the nickel-based alloy to the target surfaces, step 406 may include depositing the first formulation of the nickel-based alloy as a bond coat over the component 202 by thermal spraying process and electron beam physical vapor deposition. In yet other embodiments, the post-deposition step 406 may further include processes such as coating the turbine engine component with other suitable coating materials such as environment-resistant diffusion aluminide and/or MCrAlY overlay coatings, coating diffusion, and aging heat treatments to homogenize microstructures and improve performance of the turbine airfoils or to form thermal barrier coatings over the component. Alternate embodiments may include final machining the turbine engine component to a predetermined or original design dimension.

After the post-deposition step 406 is completed, at least one inspection process can be performed, step 408. In an embodiment, the inspection process may be employed to determine whether any surface defects exist, such as cracks or other openings, step 410. The inspection process may be conducted using any well-known non-destructive inspection techniques including, but not limited to, a fluorescent penetration inspection and a radiographic inspection. If an inspection process indicates that a surface defect exists, the turbine blade is subjected to an additional deposition process, and the process may return to either steps 402, 404, or 406. If an inspection process indicates that a surface defect does not exist, the process ends and the turbine engine component may be ready to be implemented into a turbine engine or other system.

Novel nickel-based alloys and improved methods for refurbishing turbine engine components have now been provided. Some embodiments of the novel nickel-based alloys may provide improved oxidation-resistance over conventional nickel-based alloys when subjected to typical engine operating temperatures. Other embodiments of the novel nickel-based alloys may provide improved corrosion-resistance over conventional nickel-based superalloys when subjected to typical engine operating conditions. Additionally, the methods by which the novel nickel-based alloys are applied may be employed not only on blades, but also on other turbine components, including, but not limited to, vanes and shrouds. The alloys and the methods of applying the alloys may also improve the durability of the turbine component over conventional superalloys and application methods, thereby optimizing the operating efficiency of a turbine engine, and prolonging the operational life of turbine blades and other engine components.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

1. A nickel-based alloy comprising, by weight:
about 29.5 percent to about 31.5 percent aluminum;
about 0.20 percent to about 0.60 percent hafnium;
about 0.08 percent to about 0.015 percent yttrium; and
a balance of nickel.

2. The nickel-based alloy of claim 1, further comprising, by weight,
about 31.0 percent aluminum;
about 0.25 percent to about 0.5 percent hafnium; and
about 0.01 percent yttrium.

3. The nickel-based alloy of claim 1, further comprising, by weight, about 5.0 percent chromium.

4. A nickel-based alloy consisting essentially of by weight:
about 9.7 percent to about 10.3 percent of cobalt;
about 15.5 percent to about 16.5 percent of chromium;
about 6.6 percent to about 7.2 percent of aluminum;
about 5.7 percent to about 6.3 percent of tantalum;
about 2.7 percent to about 3.3 percent of tungsten;
about 1.8 percent to about 2.3 percent of rhenium;
about 0.20 percent to about 1.2 percent of hafnium;
about 0.20 percent to about 0.60 percent of silicon;
about 0.06 percent carbon;
about 0.01 percent boron;
about 0.01 percent yttrium; and
a balance of nickel.

5. The nickel-based alloy of claim 4, consisting essentially of
about 10 percent cobalt;
about 16 percent chromium;
about 6.8 percent aluminum;
about 6.0 percent tantalum;
about 3.0 percent tungsten;
about 2.0 percent rhenium;
about 0.25 percent hafnium; and
about 0.4 percent silicon.

6. (canceled)

7. (canceled)

8. (canceled)

9. A turbine component comprising:
a substrate comprising a first alloy; and
a welded portion on the substrate, the welded portion comprising a second alloy that is different in formulation from the first alloy and selected from the group consisting of a first formulation and a second formulation, wherein:
the first formulation comprises, by weight:
about 29.5 percent to about 31.5 percent aluminum,
about 0.20 percent to about 0.60 percent hafnium,
about 0.08 percent to about 0.015 percent yttrium, and
a balance of nickel; and
the second formulation comprises, by weight:
about 9.7 percent to about 10.3 percent of cobalt,
about 15.5 percent to about 16.5 percent of chromium,
about 6.6 percent to about 7.2 percent of aluminum,
about 5.7 percent to about 6.3 percent of tantalum,
about 2.7 percent to about 3.3 percent of tungsten,
about 1.8 percent to about 2.3 percent of rhenium,
about 0.20 percent to about 1.2 percent of hafnium,
about 0.20 percent to about 0.60 percent of silicon, and
a balance of nickel.

10. The turbine component of claim 9, wherein the first formulation further comprises, by weight:
about 31.0 percent aluminum;
about 0.25 percent to about 0.5 percent hafnium; and
about 0.01 percent yttrium.

11. The turbine component of claim 9, wherein the first formulation further comprises about 5.0 percent chromium, by weight.

12. The turbine component of claim 9, wherein the second formulation further comprises, by weight:
about 10 percent cobalt;
about 16 percent chromium;
about 6.8 percent aluminum;
about 6.0 percent tantalum;
about 3.0 percent tungsten;
about 2.0 percent rhenium;
about 0.25 percent hafnium; and
about 0.4 percent silicon.

13. The turbine component of claim 9, wherein the second formulation further comprises about 0.06 percent carbon, by weight.

14. The turbine component of claim 9, wherein the second formulation further comprises about 0.01 percent boron, by weight.

15. The turbine component of claim 9, wherein the second formulation further comprises about 0.01 percent yttrium, by weight.

16. A turbine component comprising:
a substrate comprising a first alloy; and
a bond coat over the substrate, the bond coat comprising a second alloy including:
about 31.0 percent aluminum,
about 0.25 percent to about 0.5 percent hafnium,
about 0.01 percent yttrium, and
a balance of nickel.

17. The turbine component of claim 16, wherein the second alloy further comprises by weight, about 5.0 percent chromium.

18. The turbine component of claim 16, further comprising a thermal barrier coating formed over the bond coat, wherein the bond coat does not include platinum.

19. The turbine component of claim 16, wherein the second alloy consists essentially of aluminum, hathium, yttrium, nickel, and incidental impurities.

20. The turbine component of claim 16, wherein the second alloy consists essentially of aluminum, hafnium, yttrium, chromium, nickel, and incidental impurities.
